(19) United States
(12) Patent Application Publication
(10) Pub. No.: US 2009/0035987 A1
(43) Pub. Date: Feb. 5, 2009

(54) CONNECTOR ASSEMBLY

(75) Inventors: Peter R. Daly, Yorktown Heights, NY (US); Christopher J. Poulin, Carmel, NY (US)

Correspondence Address: Leason Ellis LLP, 81 Main Street, Suite 100, White Plains, NY, 10601, US

(73) Assignee: BTX Technologies, Inc., Hawthorne, NY (US)

(21) Appl. No.: 11/833,707

(22) Filed: Aug. 3, 2007

(51) Int. Cl. H01R 11/00

(52) U.S. Cl. 439/502

(57) ABSTRACT

A connector, such as an S-video connector, according to one embodiment includes an internal connector assembly and a housing. The internal connector assembly includes a pin connector that includes a plurality of pin contacts that are surrounded at least in part by a pin housing and a flexible printed circuit board that is electrically connected to the pin contacts. The connector assembly also includes a terminal block that is electrically connected to the pin contacts through the printed circuit board. The terminal block has terminal openings for receiving conductive elements associated with a cable to permit an electrical connection between the cable and the pin contacts. The housing has an inner compartment that receives and holds the internal connector assembly in non-rotatable manner, with the pin housing and pin contacts extending beyond one end of the housing.

### TECHNICAL FIELD

The present invention relates generally to an electrical connector and more particularly, to a connector, such as an S-video connector, that includes a terminal block and plastic housing, as well as having cable strain relief features.

### BACKGROUND

It is often necessary and desirable to electrically connect one component to another component especially in the ever expanding world of computers and electronics, especially in multi-media applications and settings. A number of different interfaces can be used depending upon the precise nature of the setting.

More specifically, it is often necessary in the low voltage electronic systems integration industry, such as home theater, broadcasting and audio visual, to interconnect many different devices that create a whole system.

Super video, abbreviated S-video, is an analog video signal that carries the video data as two separate signals (brightness and color), unlike composite video which carries the entire set of signals in one signal line. S-video, as most commonly implemented, carries high-bandwith 480i or 576i resolution video, i.e., standard definition video. S-video does not carry audio on the same cable. The 4-pin mini-DIN connector is the most common of several types of S-video connectors.

There is a long felt need in the industry to develop a solution to address the ease of field termination of these connectors since once the devices are installed at the installation location, the device should be easy to terminate in the field.

### SUMMARY

A connector, such as an S-video connector, according to one embodiment includes an internal connector assembly and a housing. The internal connector assembly includes a pin connector that includes a plurality of pin contacts that are surrounded at least in part by a pin housing and a flexible printed circuit board that is electrically connected to the pin contacts. The connector assembly also includes a terminal block that is electrically connected to the pin contacts through the printed circuit board. The terminal block has terminal openings for receiving conductive elements that are associated with a cable to permit an electrical connection between the cable and the pin contacts. The housing has an inner compartment that receives and holds the internal connector assembly in non-rotatable manner, with the pin housing and pin contacts extending beyond one end of the housing.

In another embodiment, a connector includes an internal connector assembly and a main housing that includes an inner compartment for receiving and holding the connector assembly. The internal connector assembly includes a base connector that includes a plurality of first contacts that are surrounded at least in part by a connector housing and the assembly includes a flexible printed circuit board that is electrically connected to the first contacts. The connector assembly further includes a terminal block that has terminal openings for receiving conductive elements associated with a cable. The terminal block has second contacts for electrical connection to the conductive elements to define an electrical connection between the conductive elements and the first contacts by means of conductive traces in the printed circuit board.

A strain relief component is disposed proximate one end of the base connector and receives and is configured to be crimped to the cable for securely attaching the cable to the internal connector assembly. The flexible printed circuit board is positionable between a relaxed position where the terminal openings of the terminal block face away from the base connector and the strain relief component and a bent position where the terminal openings face the strain relief component to permit reception of the cable therein and axial alignment between the cable and the first contacts.

Other features and advantages of the present invention will be apparent from the following detailed description when read in conjunction with the accompanying drawings.

### BRIEF DESCRIPTION OF THE DRAWING FIGURES

The foregoing and other features of the present invention will be more readily apparent from the following detailed description and drawings figures of illustrative embodiments of the invention in which:

FIG. 1 is a side perspective view of an S-video connector according to one embodiment of the present invention;

FIG. 2 is perspective view of an internal component assembly of the S-video connector of FIG. 1;

FIG. 3 is a side elevation view of the internal component assembly;

FIG. 4 is an end elevation view of the internal component assembly;

FIG. 5 is a perspective view of a first part of a housing of the S-video connector;

FIG. 6 is a perspective view of the first part of the housing;

FIG. 7 is a perspective view of a second part of the housing;

FIG. 8 is a perspective view of a first assembly step showing the attachment of a cable end to the internal component assembly;

FIG. 9 is a perspective view of a second assembly step showing the strain relief member prior to crimping;

FIG. 10 is a perspective view of a third assembly step showing the crimped cable;

FIG. 11 is a perspective view of a fourth assembly step showing the insertion of the internal component assembly into a first housing part;

FIG. 12 is an exploded perspective view of a second housing part for mating with the first housing part; and

FIG. 13 is a perspective view of the assembled S-video connector.

### DETAILED DESCRIPTION OF PREFERRED EMBODIMENTS

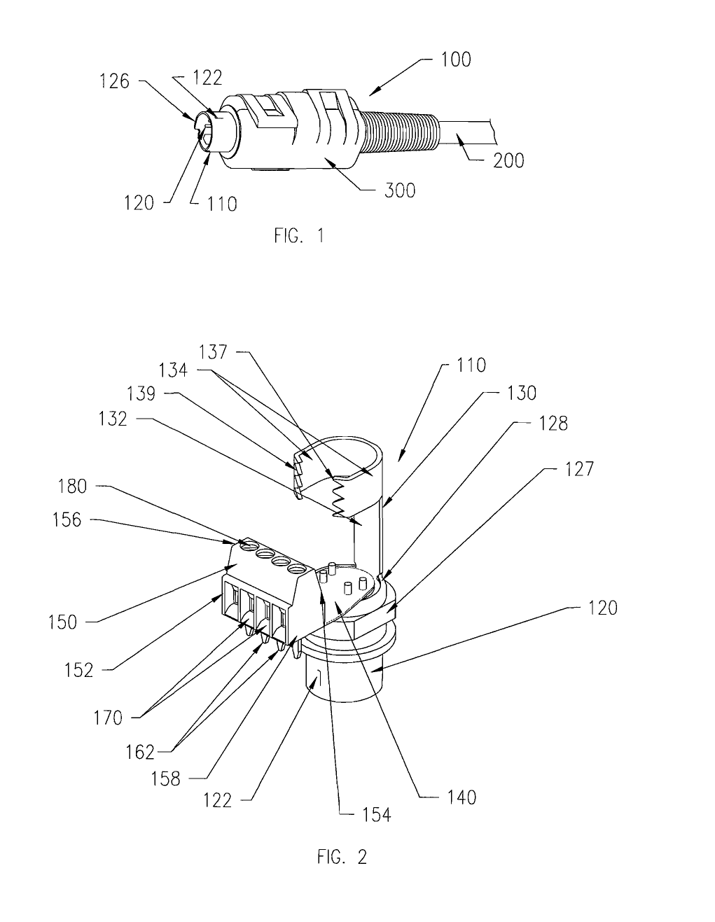

FIG. 1 is an S-video connector 100 in the form of an S-video solderless male cable end connector that includes solderless screw terminals and that fits in a plastic snap-together shell, additionally strain relief is provided by a spring steel coil that is firmly anchored in the housing as described in detail below.

The S-video connector 100 includes an internal component assembly 110 that is attached to a cable 200 and is contained within a housing 300.

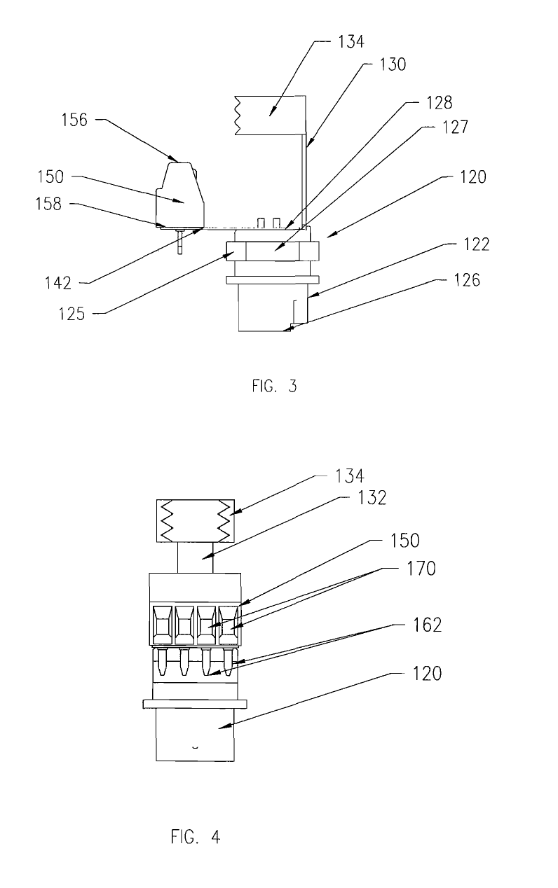

FIGS. 2-4 illustrate the internal component assembly 110 that is used to terminate the cable 200 as shown below. The internal assembly 110 includes a pin connector (base connector) 120 that includes a housing 122 that surrounds contacts 124 (FIG. 1) that are in the form of pins. In the illustrated embodiment, there are four pins 124 in the housing 122 since the S-video connector 100 is a 4 pin mini DIN connector (however, there can be more or less pins). The four pins 124 are received into a complementary connector that can be part of an electronic device, such as a television or the like. In this manner, one electronic device, such as a DVD player, can be attached to another electronic device, such as a television.

The housing 122 includes an open first end 126 through which the pins 124 are visible and accessible and an opposing second end 128. In contrast to conventional design, threads that are typically formed on the outer surface of the housing 122 of the connector member 120 have been eliminated and instead, the connector member 120 includes a flange 125. The flange 125 is constructed so that is includes flats (planar portions) 127. In the conventional design, the threads serve to retain a housing or outer shell on the pin connector member. In the present design, the flats 127 are added to the flange 125 to prevent any rotation of the connector 120 in the housing 300.

It will be appreciated that when the connector 100 is in the form of an S-video connector, the connector 120 contains contacts 124 in the form of pins; however, when the connector 100 is a different type of connector, the contact 124 can have a structure other than pins. For example, the contacts 124 can be planar members, prongs, etc.

It will therefore be appreciated that the connector 100 is not limited to being an S-video connector but can be other types of connector that employs the elements discussed herein.

The internal assembly 110 also includes a crimp strain relief 130 that is coupled to the second end 128 of the housing 122. The crimp strain relief 130 includes an elongated arm portion (an extension) 132 that extends outwardly from the second end 128 of housing 122. At the distal end of the elongated arm portion 132, there is a pair of crimp fingers 134. The crimp fingers 134 are spaced apart from one another so as to define a receiving area or space 135 for receiving cable 200 as described below. The crimp fingers 134 extend generally perpendicular to the arm portion 132. A free edge 137 of each crimp finger 134 contains serrations or teeth 139 to facilitate the coupling and engagement of the crimp fingers 134 with the cable 200. Preferably, the crimp strain relief 130 extends longitudinally along the longitudinal length of the housing 122 in a direction from the first end 126 to the second end 128.

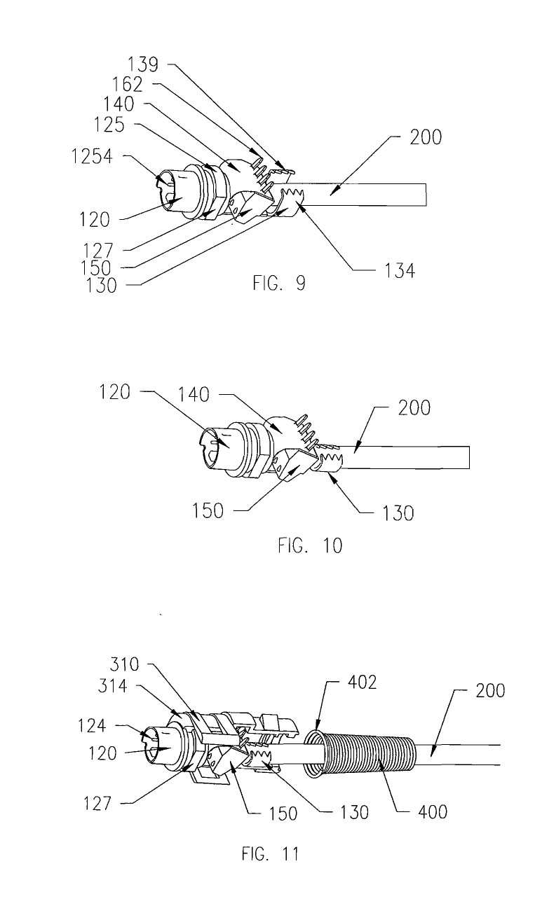

The internal assembly 110 also includes a flexible printed circuit board 140 that is electrically connected to the pins 124. The printed circuit board 140 is a flexible planar substrate that includes a first surface 142 that faces the second end 128 and an opposite second surface 144 that faces the crimp strain relief 130 when the circuit board 140 is in a relaxed, planar position. The printed circuit board 140 is disposed so that in the relaxed position, the printed circuit board 140 is generally perpendicular to the housing 122. Due to the flexibility of the circuit board 140, the printed circuit board 140 can be flexed as shown in FIG. 9. The contacts (pins 124) of the pin connector member 120 are PCB style solder pins since as shown in FIG. 2, the contacts 124 mate with and are electrically connected to the printed circuit board 140.

The internal assembly 110 also includes a terminal block 150. The terminal block 150 is disposed along the second surface 144 of the printed circuit board 140. The terminal block 150 has a first face 152 and an opposing second face 154 and an upper surface 156 and opposing lower surface 158. The terminal block 150 is coupled to and located relative to the printed circuit board 140 so that the lower surface 158 seats against the second surface 144 of the printed circuit board 140. The lower surface 158 can include a locating member that is configured to mate with a complementary locating member formed in the printed circuit board 140. For example, the locating member can be in the form of a projection or protrusion that is configured to be received within an opening formed in the region of the printed circuit board 140. When the locating member engages the opening, the terminal block 150 is supported by the printed circuit board 140.

The terminal block 150 is supported on the printed circuit board 140 with the second face 154 facing the crimp strain relief 130. The terminal block 150 includes a number of contact or terminal openings or slots 170 that are formed along the first face 152. For example, there can be four contact or terminal openings 170 that receive contacts or conductive members, such as wires, associated with cable 200 as a means for terminating the wires and provide a means for connecting the terminated wires to another electrical device, such as a television.

The terminal block 150 also includes fastening means 180 for engaging the wires or contacts inserted into the terminal openings 170 such that the wires are securely held in place within the terminal openings 170. When the wires are securely held in place within the terminal openings 170, the wires are electrically connected to conductive members that themselves are electrically connected to the conductive elements that form a part of the printed circuit board 140 as described below. The fastening means 180, as illustrated, is in the form of individual screws that are in communication with the contact openings 170. For example, each terminal opening 170 has its own fastener (screw) and therefore, after insertion of the wire into the terminal opening 170, the screw for this terminal opening 170 is tightened so as to securely attach the inserted wire to a conductive element of the terminal block 150. Thus, in the embodiment where there are four terminal openings 170, there are four fasteners 180 for engaging the wires inserted into the terminal openings 170.

In addition, the terminal block 150 includes at least one and preferably a plurality of contacts 162 that extend downwardly therefrom for mating with respective contacts of the printed circuit board 140. For example, each terminal opening 170 can have its own associated contact 162. The contact 162 can be in the form of an elongated pin or finger that passes through the opening formed in the printed circuit board 140 and then is adapted to mate with the contacts formed on the underside (first surface) of the printed circuit board 140. In this manner, all of the electrical connections between the pins 124 and the printed circuit board 140 and the terminal block 150 and the printed circuit board 140 occur along the first surface 142. It will be appreciated that the contacts 162 electrically mate with the respective contacts of the printed circuit board and through traces formed across the first surface 142, the contacts 162 are electrically connected to the pins 124.

Since the circuit board 140 is flexible, when the circuit board 140 is in the relaxed position, the entrances to the terminal openings 170 are formed along axes that are perpendicular to the longitudinal axis of the connector member 120. As will be described below, during installation, the flexible printed circuit board 140 is bent to assume a non-planar, bent position in which the upper surface 156 faces and is placed proximate the arm portion 132 of the strain relief 130. FIGS. 2-4 show the internal assembly 110 in its relaxed position.

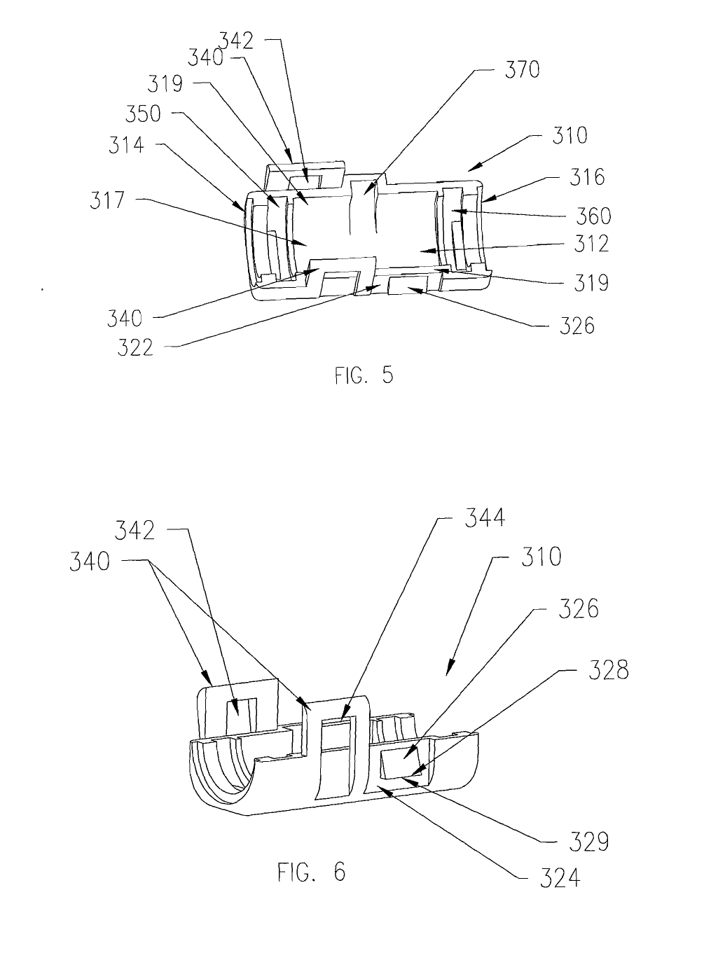

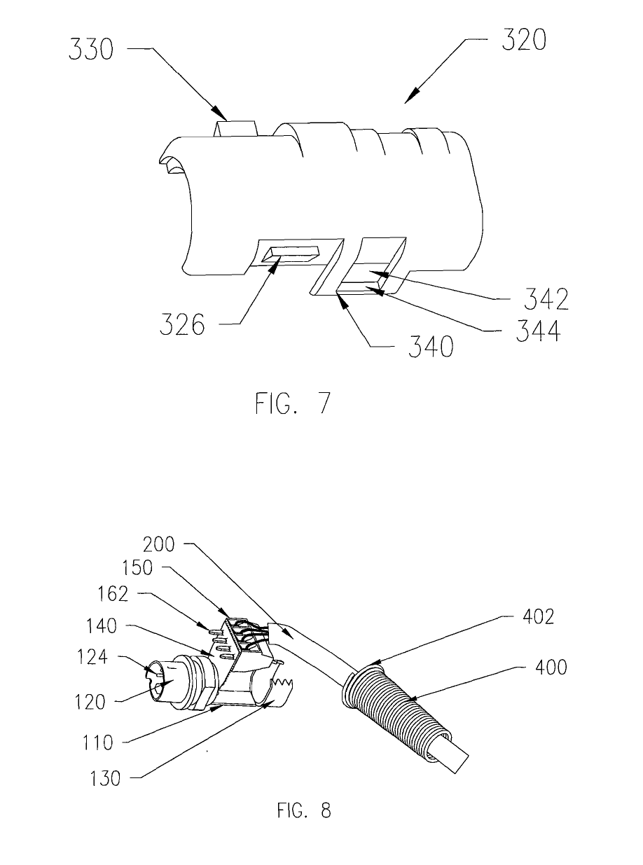

Now referring to FIGS. 5-7 in which the housing 300 that contains and surrounds the internal assembly 110 and the cable 200 is shown. The housing 300 is formed of first and second parts (shells) 310, 320 that are complementary to one another and are designed to mate with one another to form the assembled housing 300. In one embodiment, as illustrated, the first and second parts 310, 320 are identical to one another and are merely oriented differently so that the complementary fastening features mate with one another.

Since the first and second parts 310, 320 are identical, only the first part 310 will be described in detail. The first part 310 includes an arcuate shell portion 312 that has an open first end 314 and an open second end 316. The arcuate shell portion 312 has a generally semi-circular shape; however, other arcuate shapes are possible so long as the internal assembly 110 can be received and contained within the housing 300. The shell portion 312 thus includes a floor 317 and opposing side wall portions 319.

Along an outer surface 322 of one side wall portion 319, a recessed or indented section 324 is formed and includes a first locking tab 326. The first locking tab 326 preferably acts as a cam and therefore, includes an angled surface, such as a ramp 328, and a locking edge 329 that is perpendicular to and at one end of the ramp 328. In the illustrated embodiment, the first locking tab 326 has a triangular shape. Along the outer surface 322 of the other side wall portion 319, opposite the first locking tab 326 is a second locking tab 330. The second locking tab 330 is similar to the first one in that it acts as a cam and includes a ramp 328 and has a triangular shape.

The first part 310 also includes a pair of flexible locking fingers 340 each of which has an opening 342 formed therein. The opening 342 is sized and shaped to receive one of the locking tabs 326, 330 of the second part 320 when the first and second parts 310, 320 are mated together. The locking fingers 340 extend upwardly beyond the top edge of the side wall portions 319 and includes a locking edge 344. When the first and second parts 310, 320 are mated to one another and the locking fingers 340 of the first part 310 engage the locking tabs 326, 330 of the second part 320 and similarly, when the locking fingers 340 of the second part 320 engage the locking tabs 326, 330 of the first part 310, the locking finger 340 rides along the ramp 328 causing the finger 340 to slightly flex outward until the locking edge 344 clears the ramp 328 and the locking finger 340 is biased inward to its initial, relaxed position so as to cause the locking edge 344 to engage the locking edge 329 and interlock (e.g., snap-fit mechanical fit) the two parts 310, 320 to one another.

The first part 310 includes a first arcuate slot 350 formed along the side wall portions 319 and floor 317 proximate the first end 314 for receiving the flange 125 of the connector 120 and a second arcuate slot 360 formed along the side wall portions 319 and floor 317 proximate the second end 316 for receiving an end 402 (FIG. 8) of strain relief spring 400. The slots 350, 360 are therefore semi-circular in shape. It will be appreciated that since the second end 316 of the second part 320 mates with the first end 314 of the first part 310, the arcuate slot 350 of the second part 320 receives the end 402 of the strain relief spring 400 and the arcuate slot 360 of the second part 320 receives the flange 125 of the connector 120.

The first part 310 also includes an inner compartment or space 370 that is formed along an inner surface of one side wall portion 319. The compartment 370 is configured to receive the contacts 162 of the terminal block 150 when the internal assembly 110 is placed in the bent position shown in FIG. 9.

In the illustrated embodiment, the first and second parts 310, 320 mate together by a snap-fit connection; however, it will be appreciated that other attachment means can be used. For example, the two parts 310, 320 can be coupled to one another using fasteners or the like.

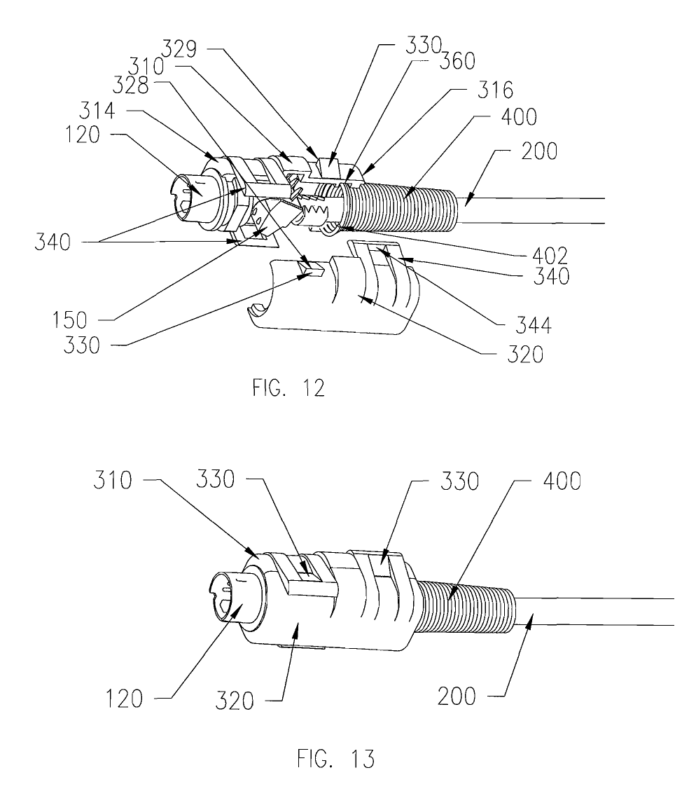

FIGS. 8-13 illustrate the steps of assembling and installing the S-video connector 100 of the present invention. As shown in FIG. 8, the installer strips the outer jacket of the cable 200 back about ½ inch and separates the two coaxial cables. Each one of the coaxial cables is bifurcated so that the center conductor and the braided shield of each can be separately inserted into the terminal openings 170 of the terminal block 150. The strain relief spring 400 is properly placed on the cable 200 with the end 402 facing the internal assembly 110 to permit the spring 400 to be later slid into place (see FIG. 12).

The fastening means 180 is then tightened with a tool (e.g., screwdriver) to affix the conductors (wires of the cable 200 within the terminal openings 170) to the connector assembly 110 and in particular, to establish an electrical connection to the pins 124 of the connector 120 by means of the circuit board 140.

The terminal block 150 is then moved toward the elongated arm portion 132 by flexing the printed circuit board 140 so as to cause the cable 200 to be laid into the space 135 between the crimp fingers 134 of the cable strain relief 130. The crimp fingers 134 are crimped to cause the teeth 139 thereof to sink into the jacketed portion of the cable 200 as shown in FIG. 10. The first end 402 of the strain relief spring 400 is pulled toward the strain relief part 130 (internal connector assembly 110) as shown in FIGS. 11 and 12.

As shown in FIG. 11, the internal connector assembly 110 is then placed into (mated with) the first part 310 of the housing 300. The flange 125 of the connector 120 is inserted into the first acruate slot 350 (FIG. 5), with the terminal block 150 being generally disposed between the two flexible locking fingers 340 and the contacts 162 being received in the space 370 (FIG. 5). As mentioned previously, the flats 127 prevent rotation of the connector 120 within the housing 300. The housing 122 of the connector 120 extends beyond the first end 314 of the shell portion 312 so that it can be plugged into a complementary connector part of an electronic device, such as a television.

It will be appreciated that the internal assembly 110 is positioned in the shell portion 312 so that it sits and is centered axially within the housing 300 (shell portions 312 of the parts 310, 320).

As shown in FIG. 12, the end 402 of the strain relief spring 400 is inserted into the second arcuate slot 360 of the first part 310.

Next, as shown in FIG. 13, the second part 320 is mated with the first part 310 and securely attached thereto. More specifically, the second end 316 of the second part 320 is aligned with the first end 314 of the first part 310. When the first and second parts 310, 320 are mated to one another and the locking fingers 340 of the first part 310 engage the locking tabs 326, 330 of the second part 320 and similarly, when the locking fingers 340 of the second part 320 engage the locking tabs 326, 330 of the first part 310, the locking finger 340 rides along the ramp 328 causing the finger 340 to slightly flex outward until the locking edge 344 clears the ramp 328 and the locking finger 340 is biased inward to its initial, relaxed position so as to cause the locking edge 344 to engage the locking edge 329 and interlock (e.g., snap-fit mechanical fit) the two parts 310, 320 to one another. This interlocking action between the first and second parts 310, 320 completes the housing assembly 300.

The S-video connector 100 offers a number of advantages over the conventional designs. For example, the connector 100 is a solderless male cable end connector. Also, the addition of the flexible circuit board 140 on the solder pins (contacts 124) of the mini-DIN 4 male (connector 120) allow a Euro style elevator clamp type of terminal block 150 to be attached to the connector 120.

It will be appreciated by persons skilled in the art that the present invention is not limited to the embodiments described thus far with reference to the accompanying drawings; rather the present invention is limited only by the following claims.

What is claimed is:

1. An S-video connector comprising:
an internal connector assembly including:
a pin connector that includes a plurality of pin contacts that are surrounded at least in part by a pin housing;
a flexible printed circuit board that is electrically connected to the pin contacts;
a terminal block that is electrically connected to the pin contacts through the printed circuit board, the terminal block having terminal openings for receiving conductive elements associated with a cable to permit an electrical connection between the cable and the pin contacts; and
a housing that has an inner compartment that receives and holds the internal connector assembly in non-rotatable manner, with the pin housing and pin contacts extending beyond one end of the housing.

2. The S-video connector of claim 1, wherein the internal connector assembly further includes a crimp strain relief component that is coupled to and extends outwardly away from the pin connector, the strain relief component including a pair of spaced crimp fingers that define a cable receiving space that is axially aligned with a longitudinal axis of the pin connector and pin contacts, the crimp fingers being crimpable about the cable so as to securely attach the cable to the internal connector assembly.

3. The S-video connector of claim 1, wherein in a relaxed position, the printed circuit board is disposed substantially perpendicular to the longitudinal axis of the connector and the terminal openings face upright to permit reception of the conductive elements of the cable and in a bent position, the terminal block is moved so that the terminal openings no longer face upright and the terminal block is disposed adjacent one end of the connector.

4. The S-video connector of claim 3, wherein the terminal block in the relaxed position of the printed circuit board is offset from a longitudinal axis of the connector.

5. The S-video connector of claim 1, wherein the pin connector includes a flange that includes at least one flat, planar portion to prevent rotation of the internal connector assembly within the housing.

6. The S-video connector of claim 1, wherein the terminal block includes a plurality of terminal contacts that are electrically connected to the printed circuit board and are accessible within the terminal openings.

7. The S-video connector of claim 6, wherein each terminal opening includes one terminal contact.

8. The S-video connector of claim 6, wherein the terminal block includes a means for fixing the conductive elements of the cable within respective terminal openings and in positions where the conductive elements are electrically connected to the terminal contacts.

9. The S-video connector of claim 1, wherein the housing includes first and second shells that are identical to one another and are mated with one another to interlockingly couple the two shells to one another and at least partially surround the internal connector assembly.

10. The S-video connector of claim 9, wherein a first end of the first shell is mated with a second end of the second shell and a first end of the second shell is mated with a second end of the first shell.

11. The S-video connector of claim 9, wherein each of the first and second shells includes a pair of locking tabs and a pair of flexible locking fingers that extend outwardly from the shell and have openings for receiving the locking tabs of the other shell.

12. The S-video connector of claim 11, wherein the locking tab has a cam surface and a locking edge that engages a locking edge formed as part of the locking finger and defining in part the opening in the locking finger.

13. The S-video connector of claim 11, wherein the pin connector includes a flange that includes at least one flat, planar portion and each of the first and second shells includes a first slot that receives the flange, the first slot being shaped so that in combination with the flat, planar portion of the flange, the internal connector assembly is prevented from rotating within the housing.

14. The S-video connector of claim 11, further including a strain relief spring that surrounds the cable and is slidable thereover and wherein each of the first and second shells includes a second slot for receiving and holding one end of the strain relief spring so as to couple the strain relief spring to the internal connector assembly.

15. The S-video connector of claim 11, wherein one of the first and second shells includes a compartment for receiving contacts that are part of the terminal block and are electrically connected to the printed circuit board.

16. An S-video connector comprising:
an internal connector assembly including:
a pin connector that includes a plurality of pin contacts that are surrounded at least in part by a pin housing;
a flexible printed circuit board that is electrically connected to the pin contacts;
a terminal block that is electrically connected to the pin contacts through the printed circuit board, the terminal block having terminal openings for receiving conductive elements associated with a cable to permit an electrical connection between the cable and the pin contacts;
a strain relief component that receives and is configured to be crimped to the cable for securely attaching the cable to the internal connector assembly; and
a housing that has an inner compartment that receives and holds the internal connector assembly, the housing being formed of two shells that mate together around at least a portion of the internal connector assembly.

17. A connector comprising:
an internal connector assembly including:
a base connector that includes a plurality of first contacts that are surrounded at least in part by a housing;
a flexible printed circuit board that is electrically connected to the first contacts;
a terminal block having terminal openings for receiving conductive elements associated with a cable, the terminal block having second contacts for connection to the conductive elements to define an electrical connection between the conductive elements and the first contacts by means of conductive traces in the printed circuit board;
a strain relief component proximate one end of the base connector that receives and is configured to be crimped to the cable for securely attaching the cable to the internal connector assembly; and
a main housing that has an inner compartment that receives and holds the internal connector assembly;
wherein the flexible printed circuit board is positionable between a relaxed position where the terminal openings of the terminal block face away from the base connector and the strain relief component and a bent position where the terminal openings face the strain relief component to permit reception of the cable therein and axial alignment between the cable and the first contacts.
